(19) United States
(12) Patent Application Publication
(10) Pub. No.: US 2012/0143538 A1
(43) Pub. Date: Jun. 7, 2012

(54) ENERGY CONSUMPTION DETECTION SYSTEM FOR ELECTRONIC DEVICE

(75) Inventor: ZI-YU ZHAN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/037,481

(22) Filed: Mar. 1, 2011

(30) Foreign Application Priority Data
Dec. 1, 2010 (CN) 201010566538.0

(51) Int. Cl. G06F 19/00

(52) U.S. Cl. 702/61

(57) ABSTRACT

An energy consumption detection system for an electronic device includes a detection device and a data processing device. The data processing device includes a signal control unit, a storage unit, and a signal setting unit. The signal control unit provides and outputs command signals, and the storage unit stores different function programs. The signal setting unit sets and runs the function program under the control of the signal control unit to activate and enable the detection device, and the detection device receives, processes, and transmits test results to the signal control unit, which generates energy consumption data accordingly.

### BACKGROUND

1. Technical Field

The disclosure generally relates to device behavior detection, and more particularly to an energy consumption detection system for an electronic device.

2. Description of the Related Art

Energy consumption detection is required for many electronic devices, such as notebooks, desktops and servers. However, most energy consumption detection devices have limited sensitivity and accuracy and are slow to provide results. In addition, most energy consumption detection devices are costly.

Therefore, there is room for improvement within the art.

### BRIEF DESCRIPTION OF THE DRAWINGS

Many aspects of an exemplary energy consumption detection system for electronic device can be better understood with reference to the following drawings. The components in the drawings are not necessarily drawn to scale, the emphasis instead being placed upon clearly illustrating the principles of the exemplary energy consumption detection system for electronic device. Moreover, in the drawings, like reference numerals designate corresponding parts throughout the several views. Wherever possible, the same reference numbers are used throughout the drawings to refer to the same or like elements of an embodiment.

FIG. 1 is a block diagram of an energy consumption detection system for an electronic device including a detection device and a data processing device, according to an exemplary embodiment.

FIG. 2 is a front view of the detection device of the energy consumption detection system shown in FIG. 1.

FIG. 3 is a rear view of the detection device of the energy consumption detection system shown in FIG. 1.

FIG. 4 is a schematic view of the data processing device of the energy consumption detection system shown in FIG. 1.

### DETAILED DESCRIPTION

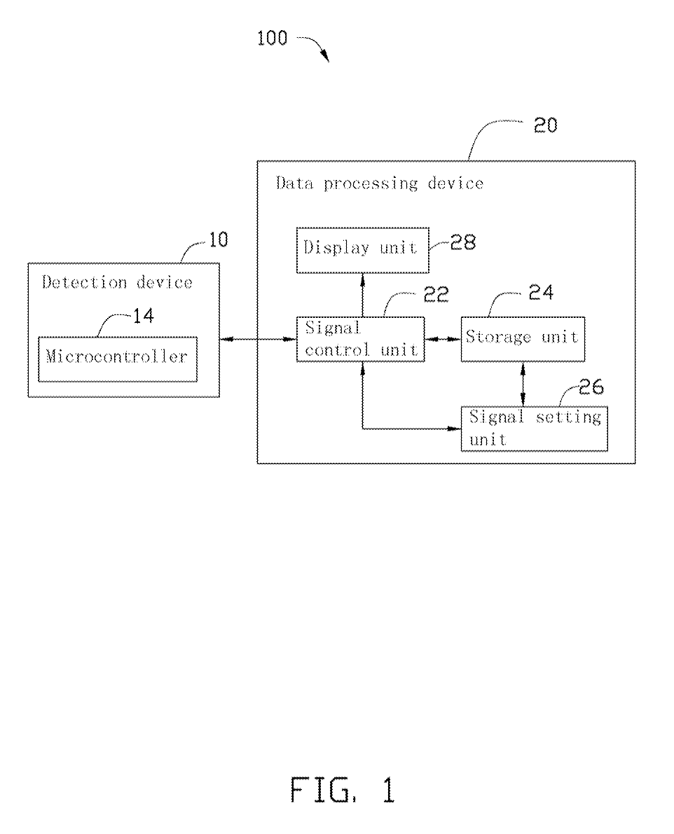

FIG. 1 shows an energy consumption detection system 100 including a detection device 10 and a data processing device 20, according to an exemplary embodiment. The energy consumption detection system 100 is applied to detect energy consumption of an electronic device under test in real time, such as a notebook, a desktop, or a server, and to further convert the energy consumption into corresponding emissions of carbon dioxide.

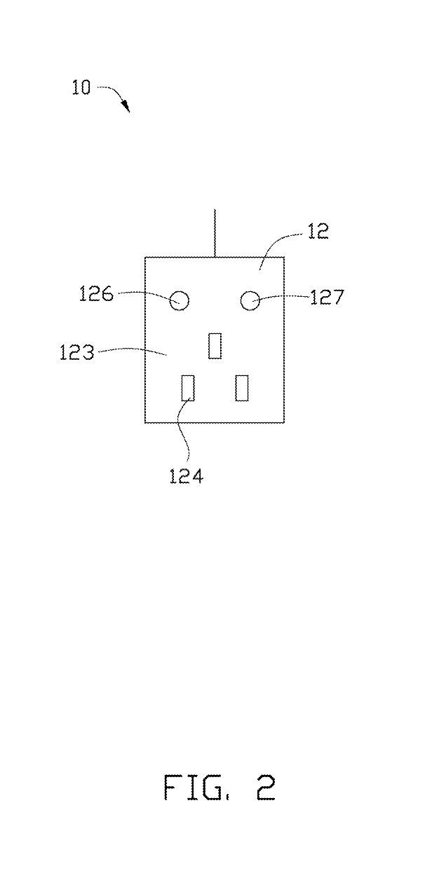

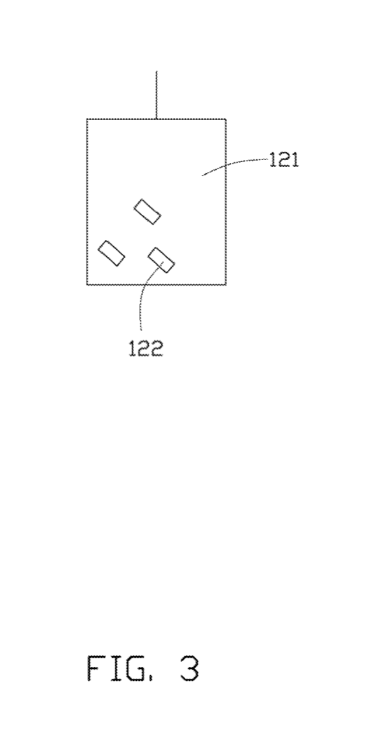

Referring to FIGS. 2 and 3, the detection device 10 is electrically connected to the data processing device 20 through a universal serial bus (USB), a universal asynchronous receiver/transmitter (UART), or other data interface. The detection device 10 is further electrically connected to the electronic device under test.

The detection device 10 includes a housing 12 and a microcontroller 14 built into the housing 12. The housing 12 includes a first surface 121, a plug 122 located on the first surface 121, a second surface 123, a socket 124 located at the second surface 123, a first indicator light 126, and a second indicator light 127. The first surface 121 and the second surface 123 are located at opposite sides of the housing 12, and are substantially parallel to each other. The first indicator light 126 and the second indicator light 127 are adjacent to the socket 124 and are located at the second surface 123.

The plug 122 is electrically connected to and received in a receptacle (not shown) to provide operating voltage for the detection device 10. In this exemplary embodiment, the socket 124 can be a three-hole power socket electrically connected to the electronic device under test, providing power thereto. For example, when the plug 122 is received in the receptacle, the detection device 10 is powered and first indicator light 126 is lit; when the detection device 10 starts to work, the second indicator light 127 is lit.

The microcontroller 14 is a small computer on a single integrated circuit (IC) containing a processor core, current sensor, voltage detector, memory, and programmable input/output peripherals. When the electronic device under test is electrically connected to the socket 124 of the detection device 10, the microcontroller 14 receives and processes current data and voltage data of the electronic device under test, and transmits the processed current and voltage data to the data processing device 20.

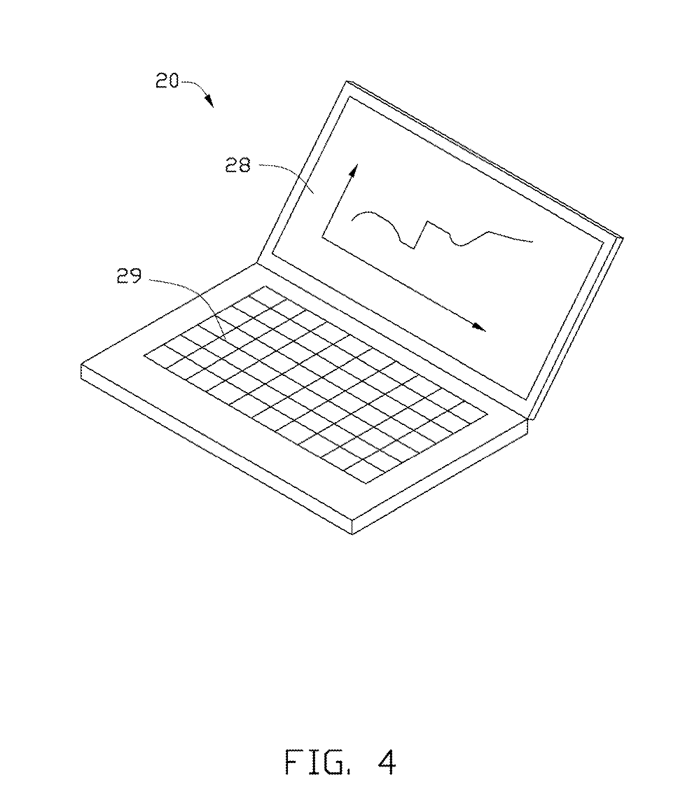

Referring to FIGS. 1 and 4, in this exemplary embodiment, the data processing device 20 can be a notebook, and is capable of controlling the detection device 10 to enable and run different test programs, and converts the current and voltage value to a corresponding curve. The data processing device 20 includes a signal control unit 22, a storage unit 24, a signal setting unit 26, a display unit 28, and a plurality of keys 29.

The signal control unit 22 can be a central processing unit (CPU) of the data processing device 20, electrically connected to and providing command signals to storage unit 24, the signal setting unit 26, the display unit 28 and the detection device 10.

The storage unit 24 can be a NAND flash for general storage and transfer of data. The storage unit 24 includes a plurality of function menu programs, such as test cycle, test date, test frequency, and storage time. In this exemplary embodiment, under the control of the signal control unit 22, the storage unit 24 automatically stores the voltage data and the current data from the detection device 10 every ten seconds. In addition, the current data and the voltage data are stored in a unified directory in the storage unit 24.

The signal setting unit 26 is electrically connected to the storage unit 24. The signal setting unit 26 receives the command signal from the signal control unit 22, and runs and accesses the function menu programs in the storage unit 24 under the control of the signal control unit 22. Thus, the data processing device 20 displays a menu setting interface on the display unit 28. Different test parameters, such as test cycle and test frequency, are input via the keys 29, and stored in the storage unit 24. The signal control unit 22 transmits a test command signal to the detection device 10 to activate and enable the microcontroller 14, so that the detection device 10 implements detection, collection, and processing of current data and voltage data of the electronic device under test according to the test parameters. The signal control unit 22 then calculates energy consumption according to the current data and the voltage data from the detection device 10, and further converts the energy consumption into corresponding emissions of carbon dioxide.

In this exemplary embodiment, the signal control unit 22 can draw and generate a curve to illustrate a relationship between time (X-axis) and corresponding energy consumption (Y-axis). The signal control unit 22 can further generate another curve to illustrate a relationship between emissions of carbon dioxide (X-axis) and corresponding energy consumption (Y-axis). The display unit 28 can be a touch screen, displaying function menus, energy consumption values, and emissions of carbon dioxide from the signal control unit 22. The display unit 28 can further display curves to monitor and calculate energy consumption, emission of carbon dioxide, and the relationship therebetween.

In use, the detection device 10 is electrically connected to the data processing device 20 and plug 122 of the detection device 10 is electrically connected to and received in the receptacle to power the detection device 10. The first indicator light 126 lights, and the electronic device under test is electrically connected to the socket 124 of the detection device 10.

The signal setting unit 26 runs and calls function menu programs in the storage unit 24 controlled by the signal control unit 22, and the function menu setting interface is displayed on the display unit 28. Via keys 29, different test parameters are input and stored in the storage unit 24. The signal control unit 22 then transmits corresponding test command signals to the detection device 10 to activate and enable the microcontroller 14, and the second indicator light 127 is lit. The detection device 10 implements detection, collection, analysis, and processing of current data and voltage data of the electronic device under test in real time according to the test parameters, and transmits test results to the signal control unit 22. For example, when the test time is exactly or substantially equal to the predetermined test time, the detection device 10 automatically stops working. Test results, including current data and voltage data are stored in the storage unit 24. The signal control unit 22 calculates energy consumption according to the current data and the voltage data, and converts the energy consumption into corresponding emissions of carbon dioxide. The signal control unit 22 generates different test curves, displayed on the display unit 28 and stored within the storage unit 24 for convenient access.

In summary, the energy consumption detection system 100 for electronic devices as disclosed detects and monitors energy consumption of an electronic device in real time, and the signal control unit 22 of the data processing device 20 generates a corresponding dynamic oscillogram to accurately quantify energy consumption and emission of carbon dioxide. Thus, the energy consumption detection system 100 is highly sensitive and accurate at a low cost.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in matters of shape, size, and arrangement of parts within the principles of exemplary disclosure to the full extent indicated by the broad general meaning of the terms in which the appended claims are expressed.

What is claimed is:

1. An energy consumption detection system used for an electronic device, comprising:
a detection device that tests the electronic device; and
a data processing device electrically connected to the detection device, the data processing device comprising:
a signal control unit electrically connected to the detection device, the signal control unit providing and outputting command signals;
a storage unit electrically connected to the signal control unit, the storage unit storing different function programs; and
a signal setting unit electrically connected to the signal control unit and the storage unit, wherein the signal setting unit sets and runs the function programs under the control of the signal control unit to activate and enable the detection device, and the detection device receives and processes test result and transmits the test result to the signal control unit, and the signal control unit generates energy consumption data according to the test result.

2. The energy consumption detection system as claimed in claim 1, wherein the test result is stored within the storage unit, and the signal control unit converts the energy consumption into corresponding emission of carbon dioxide and generates a curve to illustrate a relationship between time and corresponding energy consumption of the electronic device.

3. The energy consumption detection system as claimed in claim 1, wherein the test result is stored within the storage unit, and the signal control unit converts the energy consumption into corresponding emission of carbon dioxide and generates a curve to illustrate a relationship between emissions of carbon dioxide and corresponding energy consumption of the electronic device, the curve is stored in the storage unit.

4. The energy consumption detection system as claimed in claim 3, furthering comprising a display unit electrically connected to the signal control unit, wherein the display unit is capable of displaying function menus, energy consumption value and the emissions of carbon dioxide from the signal control unit, and the curve to monitor and calculate the energy consumption and the emissions of the carbon dioxide.

5. The energy consumption detection system as claimed in claim 1, wherein the data processing device further comprises a plurality of keys, the keys are capable of setting different test parameters, when the different test parameters are input and stored in the storage unit, the signal control unit transmits the test parameters to the detection device to activate and enable the detection device to implements detection, collection, and processing of current data and voltage data of the electronic device.

6. The energy consumption detection system as claimed in claim 1, wherein the detection device comprises a microcontroller, the microcontroller comprises a processor core, current sensors, a voltage detector, memories, and programmable input/output peripherals, and the microcontroller is capable of receiving and processing current data and voltage data from the detection device, and transmitting the current and voltage data to the data processing device.

7. The energy consumption detection system as claimed in claim 1, wherein the signal setting unit sets and inputs test time of the electronic device, when the test time is exactly or substantially equals the predetermined test time, the detection device automatically stops working.

8. The energy consumption detection system as claimed in claim 1, wherein the detection device comprises a housing, and the housing comprises a first surface and a plug located on the first surface, the plug is electrically connected to and received in a receptacle to provide operating voltage for the detection device.

9. The energy consumption detection system as claimed in claim 8, wherein the housing further comprises a second surface and a socket located at the second surface, the first surface and the second surface are located at opposite sides of the housing and are substantially parallel to each other, and the socket is electrically connected to the electronic device to provide power for the electronic device.

10. The energy consumption detection system as claimed in claim 9, wherein the housing further comprises a first indicator light and a second indicator light, the first indicator light and the second indicator light are adjacent to the socket and are located at the second surface, when the plug is received in the receptacle, the detection device is powered, the first indicator light is lit; when the detection device starts to work, the second indicator light is lit.

11. An energy consumption detection system used for an electronic device, comprising:
a detection device electrically connected to the electronic device for testing the electronic device; and
a data processing device electrically connected to the detection device, the data processing device comprising:
a signal control unit electrically connected to the detection device, the signal control providing and outputting command signals;
a storage unit electrically connected to the signal control unit, the storage unit storing different test parameters; and
a signal setting unit electrically connected to the signal control unit and the storage unit, wherein the signal setting unit sets and runs the function programs controlled by the signal control unit to activate and enable the detection device, and the detection device receives and processes current data and voltage data of the electronic device and transmits the processed current and voltage data to the signal control unit in real time, and the signal control unit calculates energy consumption according to the processed current data and voltage data, and converts the energy consumption into corresponding emissions of carbon dioxide.

12. The energy consumption detection system as claimed in claim 11, wherein the current data and the voltage data are stored within the storage unit, and the signal control unit converts the energy consumption into corresponding emission of carbon dioxide and generates a curve to illustrate a relationship between time and corresponding energy consumption of the electronic device.

13. The energy consumption detection system as claimed in claim 11, wherein the current data and the voltage data are stored within the storage unit, and the signal control unit converts the energy consumption into corresponding emission of carbon dioxide and generates a curve to illustrate a relationship between emissions of carbon dioxide and corresponding energy consumption of the electronic device, the curve is stored in the storage unit.

14. The energy consumption detection system as claimed in claim 13, furthering comprising a display unit electrically connected to the signal control unit, wherein the display unit is capable of displaying function menus, energy consumption value and the emissions of carbon dioxide from the signal control unit and the curve to monitor and analyze the energy consumption and the emissions of the carbon dioxide.

15. The energy consumption detection system as claimed in claim 11, wherein the data processing device further comprises a plurality of keys, the keys are capable of setting different test parameters, when the different test parameters are input and stored in the storage unit, the signal control unit transmits the test parameters to the detection device to activate and enable the detection device to detect, collect and process current data and voltage data of the electronic device.

16. The energy consumption detection system as claimed in claim 11, wherein the detection device comprises a microcontroller, the microcontroller comprises a processor core, current sensors, a voltage detector, memories, and programmable input/output peripherals, and the microcontroller is capable of receiving and processing the current data and the voltage data from the detection device, and transmitting the current and voltage data to the data processing device.

17. The energy consumption detection system as claimed in claim 11, wherein the signal setting unit sets and inputs test time of the electronic device, when the test time is exactly or substantially equals the predetermined test time, the detection device automatically stops testing.

18. The energy consumption detection system as claimed in claim 11, wherein the detection device comprises a housing, and the housing comprises a first surface and a plug located on the first surface, the plug is electrically connected to and received in a receptacle to provide operating voltage for the detection device.

19. The energy consumption detection system as claimed in claim 18, wherein the housing further comprises a second surface and a socket located at the second surface, the first surface and the second surface are located at opposite sides of the housing and are substantially parallel to each other, and the socket is electrically connected to the electronic device to provide power for the electronic device.

20. The energy consumption detection system as claimed in claim 19, wherein the housing further comprises a first indicator light and a second indicator light, the first indicator light and the second indicator light are adjacent to the socket and are located at the second surface, when the plug is received in the receptacle, the detection device is powered, the first indicator light is lit; when the detection device starts to work, the second indicator light is lit.
